(19) United States
(12) Patent Application Publication
(10) Pub. No.: US 2008/0254363 A1
(43) Pub. Date: Oct. 16, 2008

(54) Electrochemical energy storage device

(76) Inventors: Tooru MATSUI, Osaka (JP); Masaki DEGUCHI, Hyogo (JP); Hiroshi YOSHIZAWA, Osaka (JP)

Correspondence Address: MCDERMOTT WILL & EMERY LLP, 600 13TH STREET, NW, WASHINGTON, DC, 20005-3096, US

(21) Appl. No.: 11/979,403

(22) Filed: Nov. 2, 2007

(30) Foreign Application Priority Data
Nov. 2, 2006 (JP) 2006-298818

(51) Int. Cl. H01M 10/26

(52) U.S. Cl. 429/207

(57) ABSTRACT

The present invention provides an electrochemical energy storage device comprising a positive electrode, a negative electrode, and a non-aqueous electrolytic solution containing an ammonium salt, wherein the negative electrode potential upon completion of charging is set to less than 1.8 V and 0.1 V or more relative to a lithium reference in which high electric capacity is obtained and a reductive decomposition reaction of the ammonium salt on the negative electrode is avoided, and thus efficiency upon every charging and discharging cycle is improved, resulting in a long cycle life.

### BACKGROUND OF THE INVENTION

1. Field of the Invention

The present invention relates an electrochemical energy storage device such as an electrical double layer capacitor, a hybrid capacitor and a secondary battery, and particularly to an electrochemical energy storage device having optimized balance between positive electrode capacity and negative electrode capacity.

2. Description of the Related Art

In an electrical double layer capacitor using a polarizable electrode as a positive electrode and a negative electrode, electrochemical energy is stored by adsorbing cations and anions in a non-aqueous electrolytic solution on the electrode surface during a charging process. It is a feature of the electrical double layer capacitor that electrochemical energy is stored by adsorbing cations and anions on the electrode surface, thus enabling charging and discharging at a high speed. A carbon material such as activated carbon having a high specific surface area is commonly used for the polarizable electrode so as to adsorb a lot of anions and cations. Also, a non-aqueous electrolytic solution is used as an electrolytic solution so as to set a charging voltage of the electrical double layer capacitor to a high voltage. As the non-aqueous electrolytic solution, a solution dissolving an ammonium salt such as tetraethylammonium tetrafluoroborate in a non-aqueous solvent such as an organic carbonate is used. The charging voltage of the electrical double layer capacitor is approximately 2.3 V and it is difficult to further increase the charging voltage. One of the reasons is that the non-aqueous solvent such as the organic carbonate is reductively decomposed on the negative electrode. After the completion of charging, the potential of the negative electrode is 1.8 V or more relative to a lithium reference, depending on the capacitor.

In a lithium ion battery using a layered transition metal oxide such as LiCoO₂ as a positive electrode material and a layered compound such as graphite as a negative electrode material, electrochemical energy is stored by migrating lithium ions in the positive electrode material into the negative electrode material during a charging process. As the electrolytic solution, a solution dissolving a lithium salt such as lithium hexafluorophosphate (hereinafter abbreviated to LiPF₆) in a non-aqueous solvent such as an organic carbonate is used. Since lithium ions are extracted from interlayers of the positive electrode material and inserted into interlayers of the negative electrode material during the charging process, it becomes difficult to charge at a high speed as compared with the electrical double layer capacitor. On the other hand, the lithium ion battery can store much more electrochemical energy than the electrical double layer capacitor. One of the reasons is that the charging voltage can be increased to approximately 4.2 V because the potential of the negative electrode after completion of charging can be lowered to 0.1 V or less relative to a lithium reference.

A hybrid-type electrochemical energy storage device which is capable of charging and discharging at a high speed and storing comparatively much electrochemical energy by coupling a polarizable electrode of an electrical double layer capacitor with an electrode material used in a lithium ion battery has recently been proposed. For example, in a hybrid capacitor proposed by Patent Document 1 (Japanese Unexamined Patent Publication No. 11-144759), activated carbon is used as the positive electrode material, a carbon fiber having a developed graphite structure is used as the negative electrode material, and a solution dissolving an ammonium salt and a lithium salt in a solvent containing an organic carbonate is used as the electrolytic solution. In this electrolytic solution, the ammonium salt is added so as to reduce resistance of the electrolytic solution. Also, lithium ions are preliminary inserted into the graphite-based material used in the negative electrode of this hybrid capacitor by using an electrochemical method, for example, by arranging an electrode made of the graphite-based material and a lithium metal facing each other in an electrolytic solution comprising an organic solvent in which only a lithium salt is dissolved, and by applying a cathodic current to the graphite-based electrode.

### SUMMARY OF THE INVENTION

As a result of an intensive study on the hybrid capacitor as proposed by Patent Document 1 after assembling, the present inventors have found that, when charging and discharging cycles are repeated, efficiency upon every charging and discharging cycle is lowered, resulting in a short cycle life.

The present invention has been made under these circumstances, and an object thereof is to provide an electrochemical energy storage device in which high electric capacity is obtained and a reductive decomposition reaction of an ammonium salt on a negative electrode is avoided, and thus efficiency upon every charging and discharging cycle is improved, resulting in a long cycle life.

An aspect of the present invention is directed to an electrochemical energy storage device comprising a positive electrode, a negative electrode, and a non-aqueous electrolytic solution containing an ammonium salt, wherein a negative electrode potential upon completion of charging is set to less than 1.8 V and 0.1 V or more relative to a lithium reference.

Objects, features, aspects and advantages of the present invention become more apparent upon reading the following detailed description.

### DETAILED DESCRIPTION OF THE INVENTION

The present inventors assembled the hybrid capacitor as proposed by Patent Document 1 and performed the intensive study thereon. As a result, the present inventors have found that, when charging and discharging cycles are repeated, efficiency upon every charging and discharging cycle is lowered, resulting in a short cycle life.

According to the investigation, in the hybrid capacitor, for example, in which tetraethylammonium tetrafluoroborate (hereinafter abbreviated to TEA·BF₄) is used as an ammonium salt and an artificial graphite powder is used as a negative electrode material, the following side reaction arises. The reason why the efficiency upon every charging and discharging cycle is lowered resulting in a short cycle life can be elucidated by this side reaction.

In a process corresponding to charging of an electrochemical energy storage device such as the hybrid capacitor, when a negative electrode potential is gradually decreased by applying a cathodic current to the negative electrode, there arises a reaction of inserting tetraethylammonium cations (hereinafter abbreviated to TEA ions) derived from the ammonium salt into interlayers of the artificial graphite powder used as the negative electrode. In particular, when anions of the ammonium salt are tetrafluoroborate ions (hereinafter abbreviated to BF₄ ions), this insertion reaction becomes remarkable. However, since the potential at which this insertion reaction arises is almost the same as the potential at which the non-aqueous solvent such as an organic carbonate is reductively decomposed to form a film on the negative electrode, the reaction of inserting TEA ions is terminated soon when the film is formed. When the cathodic current is further continuously applied to the negative electrode, there arises a reaction, which is considered as a reductive decomposition reaction of TEA·BF₄, at the potential of approximately 0.08, V relative to a lithium reference. The reaction, which is considered as the reductive decomposition reaction of the ammonium salt, is an irreversible reaction, and thereby, it becomes impossible to store electrochemical energy to a lower potential.

The equilibrium potential of the negative electrode in which many lithium ions are inserted into the graphite-based material such as the artificial graphite powder, as proposed in the aforementioned Patent Document 1, is about 0.09 V relative to a lithium reference and is extremely close to the potential at which the reductive decomposition reaction of TEA·BF₄ arises. During a charging process of an actual electrochemical energy storage device, the potential of the negative electrode becomes lower than the equilibrium potential because of reaction overvoltage and concentration overvoltage, and thus the reductive decomposition reaction of TEA·BF₄ is promoted. Consequently, in the electrochemical energy storage device as proposed in Patent Document 1, the discharge capacity decreases, and thus the efficiency upon every charging and discharging cycle is lowered resulting in a short cycle life.

The electrochemical energy storage device of the present embodiment comprises a positive electrode, a negative electrode, and a non-aqueous electrolytic solution containing an ammonium salt, wherein a negative electrode potential upon completion of charging is set to less than 1.8 V and 0.1 V or more relative to a lithium reference.

In the electrochemical energy storage device of the present embodiment, the negative electrode potential upon completion of charging is set to less than 1.8 V relative to the lithium reference. The present inventors set to change the lower limit of the negative electrode potential upon completion of charging within a range from 2.3 to 0.1 V relative to the lithium reference, and measured the electric capacity at each lower limit of the potential after repeating the charging and discharging cycle. As a result, when the lower limit of the potential is within a range from 2.3 to 1.8 V relative to the lithium reference, the effect of increasing the electric capacity is small even if the lower limit of the potential is lowered. However, when the lower limit of the potential becomes less than 1.8 V, the falling of the lower limit of the potential remarkably increased the electric capacity (Table 2). Based on this finding, by setting the negative electrode potential upon completion of charging to less than 1.8 V, it is possible to achieve a relatively larger negative electrode capacity to a lowering of the negative electrode potential, in comparison with setting to 1.8 V or more. Also, by setting the negative electrode potential upon completion of charging to less than 1.8 V, it is possible to store more electrochemical energy than that of the electrical double layer capacitor in which the negative electrode potential upon completion of charging is 1.8 V or more.

To increase the negative electrode capacity, the negative electrode potential upon completion of charging is preferably set to 1.0 V or less, and far preferably 0.5 V or less, relative to the lithium reference.

In the electrochemical energy storage device of the present embodiment, the negative electrode potential upon completion of charging is set to 0.1 V or more relative to the lithium reference. According to the investigation performed by the present inventors, in which the negative electrode potential upon completion of charging was set within a range from 0.7 to 0.08 V relative to the lithium reference and the discharge capacity was measured after repeating charging and discharging cycles, the ratio of the discharge capacity of the 1,000th cycle to that of the 10th cycle decreased discontinuously at the negative electrode potential of less than 0.1 V as compared with that of 0.1 V or more (Table 1). This is because the reductive decomposition reaction of the ammonium salt is promoted when the charge potential of the negative electrode is less than 0.1 V. The negative electrode potential, at which the reaction considered to be the reductive decomposition reaction of an ammonium salt, especially the ammonium salt such as TEA·BF₄ containing a BF₄ ion as an anion, arises, is approximately 0.08 V relative to the lithium reference. Therefore, taking generation of reaction overvoltage and concentration overvoltage during the charging process into account, it is possible to prevent the reductive decomposition reaction of the ammonium salt from arising on the negative electrode by setting the negative electrode potential upon completion of charging to approximately 0.1 V or more relative to the lithium reference. Consequently, balance between the positive electrode capacity and the negative electrode capacity is optimized, and thus the efficiency upon every charging and discharging cycle is not lowered and cycle life is not shortened even if the charging and discharging cycles are repeated.

The electrochemical energy to be stored by the electrochemical energy storage device of the present embodiment may be electrical double layer capacity formed on the interface between the electrode and the electrolytic solution, or a change in electrochemical potential energy of the material used as the electrode.

Examples of the material used for the negative electrode in the present embodiment include carbon materials such as activated carbon, carbon black, non-graphitizable carbon, a graphite-based material, a carbon nanotube and fullerene. Also, the material may be conductive polymers such as polyacetylene and polyparaphenylene. Also, the material may be lithium metal and metals capable of alloying with lithium (for example, Ag, Au, Zn, Al, Ga, In, Si, Ge, Sn, Pb and Bi), oxides of Si and Sn, and lithium-containing transition metal oxides (for example, Li₄Ti₅O₁₂). Furthermore, the material may be metal oxides such as CoO, NiO and MnO, which can react with lithium and decompose into the metal and lithium oxide.

Among these negative electrode materials, a mixed negative electrode material containing carbon black and a metal oxide capable of inserting and extracting lithium ions or reacting with lithium is preferred in view of having both a function of serving for an electrical double layer capacitor and a function of serving for a nonaqueous-electrolytic-solution secondary battery. Carbon black has a small surface area and a small electrical double layer capacity as compared with activated carbon. However, carbon black has a few functional groups capable of reacting with lithium on the surface and therefore can suppress the amount reacting irreversibly with lithium. Consequently, a large discharge capacity can be obtained especially when the negative electrode potential upon charging is charged to less than 1.8 V relative to the lithium reference. Also, there is an advantage to increase the negative electrode capacity, since the metal oxide has an electrical double layer capacity and is capable of inserting and extracting lithium ions at the potential of less than 1.8 V.

Examples of the material used for the positive electrode in the present embodiment, similarly to the case of the negative electrode, include carbon materials such as activated carbon, carbon black, non-graphitizable carbon, graphite-based material, carbon nanotube and fullerene. Also, the material may be conductive polymers such as polyacetylene, polypyrrole and polythiophene. Furthermore, the material may be lithium complex oxides such as lithium cobaltate, lithium nickelate, lithium manganate and lithium phosphate. Among these positive electrode materials, a mixed positive electrode material containing activated carbon black and a lithium comosite oxide is preferred in view of having both a function of serving for an electrical double layer capacitor and a function of serving for a nonaqueous-electrolytic-solution secondary battery.

The ammonium salt contained in the non-aqueous electrolytic solution of the present embodiment is composed of an ammonium cation, and an anion which forms the salt with the cation.

The ammonium cation of the ammonium salt is preferably a quaternary ammonium cation comprising straight-chain alkyl groups each having 4 or less carbon atoms. The cation includes a quaternary ammonium ion in which each of four alkyl groups bonded to N (nitrogen) of the ammonium ion independently represents a methyl group, an ethyl group, a propyl group or a butyl group. An ammonium ion having a branched alkyl group tends to be oxidized. The ammonium salts containing these ammonium cations may be used alone or in combination.

Among these ammonium ions, ammonium ions having three methyl groups and one methyl group or straight-chain alkyl group, such as a tetramethylammonium ion (hereinafter abbreviated to a TMA ion), a trimethylethylammonium ion (hereinafter abbreviated to a TMEA ion), a trimethylpropylammonium ion (hereinafter abbreviated to a TMPA ion) and a trimethylbutylammonium ion (hereinafter abbreviated to a TMBA ion) are preferred. The ammonium ions having three or more methyl groups can suppress a reaction of inserting the ammonium ions into the interlayers existing in the carbon material used as the negative electrode. In particular, the TMPA ion has the effect of not only suppressing the reaction of inserting the TMPA ions into the interlayers existing in the carbon material, but also obtaining an electrolytic solution dissolving the ammonium salt in a high concentration.

Examples of the anion of the ammonium salt include, but are not limited to, a BF₄ ion, a bis[trifluoromethanesulfonyl]imide ion (hereinafter abbreviated to a TFSI ion), a perchlorate ion (hereinafter abbreviated to a ClO₄ ion), a hexafluorophosphate ion (hereinafter abbreviated to a PF₆ ion), a bis[pentafluoroethanesulfonyl]imide ion (hereinafter abbreviated to a BETI ion), a [trifluoromethanesulfonyl][nonafluorobutanesulfonyl]imide ion (hereinafter abbreviated to a MBSI ion), a cyclohexafluoropropane-1,3-bis[sulfonyl]imide ion (hereinafter abbreviated to a CHSI ion), a bis[oxalate(2-)]borate ion (hereinafter abbreviated to a BOB ion), a trifluoromethyl trifluoroborate ion (hereinafter abbreviated to a CF₃BF₃ ion), a pentafluoroethyl trifluoroborate ion (hereinafter abbreviated to a C₂F₅BF₃ ion), a heptafluoropropyl trifluoroborate ion (hereinafter abbreviated to a C₃H₇BF₃ ion) and a tris[pentafluoroethyl]trifluorophosphate ion (hereinafter abbreviated to a (C₂F₅)₃PF₃ ion). The ammonium salts containing these anions may be used alone or in combination.

Among these anions, the BF₄ ion is preferred in view of being capable of preparing an electrolytic solution dissolving the ammonium salt in a high concentration. Therefore, when the ammonium salt composed of the BF₄ ion and the TMPA ion is used, an electrolytic solution having a high salt concentration can be obtained. Also, the TFSI ion, the BETI ion, the ClO₄ ion, the CF₃BF₃ ion and the C₂F₅BF₃ ion are preferred in view of suppressing the reaction of inserting the ammonium cations into the interlayers of the carbon material of the negative electrode. Furthermore, the BOB ion is preferred in view of having the effect that it is decomposed on the negative electrode to form a stable film, enabling to suppress the reaction of inserting the ammonium cations into the interlayers existing in the carbon material and thus to improve the charging and discharging cycle life of the electrochemical energy storage device. When an ammonium salt containing the BF₄ ion and the PF₆ ion is used, it is preferred to allow the BOB ion to coexist in view of forming the stable film to suppress the reaction of inserting the ammonium cations into the interlayers existing in the carbon material.

Examples of the non-aqueous solvent for a non-aqueous electrolytic solution include cyclic carbonates such as ethylene carbonate (hereinafter abbreviated to EC), propylene carbonate (hereinafter abbreviated to PC) and butylene carbonate (hereinafter abbreviated to BC); cyclic esters such as γ-butyrolactone (hereinafter abbreviated to γ-BL); and linear carbonates such as dimethyl carbonate (hereinafter abbreviated to DMC), ethylmethyl carbonate (hereinafter abbreviated to EMC) and diethyl carbonate (hereinafter abbreviated to DEC). These solvents may be used alone or in combination.

Among these carbonates, EC, PC and γ-BL are preferred in view of being capable of dissolving the ammonium salts in a high concentration. For example, EC can dissolve trimethylpropylammonium tetrafluoroborate (TMPA·BF₄) of 1 mole in EC of 3 moles resulting in a high concentration.

The cyclic carbonate includes, in addition to EC, PC and BC, fluoroethylene carbonate. Examples of a cyclic carbonate having a C═C unsaturated bond among cyclic carbonates include vinylene carbonate, vinylethylene carbonate, divinylethylene carbonate, phenylethylene carbonate and diphenyethylene carbonate.

The cyclic ester includes, in addition to γ-BL, α-methyl-γ-butyrolactone and γ-valerolactone, and examples of a cyclic ester having a C═C unsaturated bond among cyclic esters include furanone, 3-methyl-2(5H)-furanone and α-angelicalactone.

The linear carbonate includes, in addition to DMC, EMC and DEC, methylpropyl carbonate and methylbutyl carbonate. Examples of a linear carbonate having a C═C unsaturated bond among linear carbonates include methylvinyl carbonate, ethylvinyl carbonate, divinyl carbonate, allylmethyl carbonate, allylethyl carbonate, diallyl carbonate, allylphenyl carbonate and diphenyl carbonate.

The non-aqueous electrolytic solution of the present embodiment preferably contains, in addition to the ammonium salt, a lithium salt. By allowing the lithium ions to exist in the non-aqueous electrolytic solution, an energy storage material employed in a lithium ion battery can be used for positive and negative electrodes, thus exerting the effect of being capable of not only improving an energy density of the electrochemical energy storage device, but also suppressing the reaction of inserting the ammonium ions into the interlayers existing in the carbon material of the negative electrode. The reason why the lithium salt can suppress the reaction of inserting the ammonium ions into the interlayers is considered that it increases the viscosity of the electrolytic solution thereby preventing the ammonium ions from migrating into the interlayers.

The lithium salt is preferably lithium tetrafluoroborate (hereinafter abbreviated to LiBF₄), lithium bis[trifluoromethanesulfonyl]imide (hereinafter referred to as LiTFSI), lithium perchlorate (hereinafter abbreviated to LiClO₄), lithium bis[pentafluoroethanesulfonyl]imide (hereinafter abbreviated to LiBETI), lithium trifluoromethyl trifluoroborate (hereinafter abbreviated to LiCF₃BF₃), or lithium pentafluoroethyl trifluoroborate (hereinafter abbreviated to LiC₂F₅BF₃). Also, when LiBF₄ is used, it is preferred to allow lithium bis [oxalate (2-)]borate (hereinafter abbreviated to LiBOB) to coexist. LiBOB forms a stable film on the negative electrode and thereby can suppress the reaction of inserting the ammonium ions into the interlayers.

In the present embodiment, when the non-aqueous electrolytic solution contains the lithium salt and the ammonium salt, the molar ratio of the lithium salt to the ammonium salt is preferably from 1.0/0.6 to 0.6/1.0, and more preferably about 1/1, in terms of the ratio lithium salt/ammonium salt. In particular, when the lithium salt is LiBF₄, LiTFSI or LiClO₄, and the cation of the ammonium salt is the TMPA ion and the anion is the BF₄ ion, the TFSI ion or the ClO₄ ion, the non-aqueous electrolytic solution having a high concentration can be obtained by adjusting the molar ratio of the lithium salt and the ammonium salt to 1/1.

While embodiments of the present invention have been described in detail, these are exemplary of the invention in all aspects and are not to be considered as limiting. It should be understood that numerous modifications that are not illustrated can be made without departing from the scope of the present invention.

The present invention will now be described by way of examples, but the present invention is not limited to the following examples.

### EXAMPLES

### Example 1

### Confirmation of Reductive Decomposition Potential of Ammonium Salt and Production of Electrical Double Layer Capacitor Electrode

A working electrode made of acetylene black and a CoO powder having an average particle size of 30 nm was produced according to a method of Do et al. (J. S. Don and C. H. Weng, Journal of Power Sources, Vol. 146, page 482 (2005)) and a reductive decomposition potential of an ammonium salt was measured.

First, acetylene black, the CoO powder and polyvinylidene fluoride as a binder were weighed in a weight ratio of 10:80:10 and then mixed with N-methyl-2-pyrrolidone to form a paste. The paste thus obtained was applied on a copper current collecting foil and dried, and then the coated copper current collecting foil was cut into pieces measuring 35 mm×35 mm. The copper current collecting foil comprising a paste layer formed thereon was ultrasonic-welded to a 0.5 mm thick copper current collecting plate with a lead to produce a working electrode.

As a counter electrode, a foil-like electrode for an electrical double layer capacitor available from Hohsen Corporation was used after cutting into pieces. Also, a silver wire was used as a reference electrode, and a correction to a potential relative to a lithium reference was conducted.

As a non-aqueous electrolytic solution, a mixture obtained by mixing EC and TEA·BF₄ in a molar ratio EC:TEA·BF₄=8:1 was used.

The natural potential of the working electrode at 20° C. was 2.9 V vs. Li/Li+. To the working electrode, a cathodic current of 0.0003 mA/cm² was applied. As a result, the potential became constant at 0.08 V vs. Li/Li+, and this potential was taken as a reductive decomposition potential of TEA·BF₄.

Subsequently, to the working electrode produced in the same manner, a cathodic current and an anodic current were repeatedly applied at a current density of 0.03 MA/cm² within a range from 2.9 V vs. Li/Li+ to 0.1 V vs. Li/Li+, and then the electric capacity of the working electrode was measured. After 5 cycles, the electric capacity upon applying the cathodic current and the electric capacity upon applying the anodic current became almost the same value at 0.16 mAh, and this value was taken as the electrical double layer capacity. Also, a value obtained by subtracting an integrated anodic current from an integrated cathodic current until the 5th cycle was 0.031 mAh. This value was defined as the irreversible capacity.

Next, an electrical double layer capacitor was assembled in the following manner.

First, the electrical double layer capacity of the working electrode was adjusted to 0.50 mAh (an irreversible capacity being 0.097 mAh) by increasing the amount of the paste to be applied on the copper foil without varying the weight ratio of acetylene black, the CoO powder and polyvinylidene fluoride. The working electrode having the electric capacity of 0.50 mAh was used as the negative electrode for the electrical double layer capacitor.

Acetylene black, a fine activated carbon powder (MCSP manufactured by Calgon Mitsubishi Chemical Corporation) and polyvinylidene fluoride were weighed in a weight ratio of 10:80:10 and then mixed with N-methyl-2-pyrrolidone to form a paste. The paste thus obtained was applied on an aluminum current collecting foil and dried, and then the coated aluminum current collecting foil was cut into pieces measuring 35 mm×35 mm. The aluminum current collecting foil comprising a paste layer formed thereon was ultrasonic-welded to a 0.5 mm thick aluminum current collecting plate with a lead to produce a working electrode.

The natural potential at 20° C. of the working electrode using the fine activated carbon powder was 2.9 V vs. Li/Li+. To the working electrode, a cathodic current and an anodic current were repeatedly applied at a current density of 0.03 mA/cm² within a range from 2.9 V vs. Li/Li+ to 4.0 V vs. Li/Li+, and then the electric capacity of the working electrode was measured. The potential varied linearly with time and the electrical double layer capacitor capacity of the working electrode was 0.60 mAh. The working electrode having the electric capacity of 0.60 mAh was used as the positive electrode for the electrical double layer capacitor.

As a non-aqueous electrolytic solution, a mixture obtained by mixing EC, EMC and TEA·BF₄ in a molar ratio EC:EMC:TEA·BF₄=3:8:1 was used.

The negative and positive electrodes for the electrical double layer capacitor facing each other with a nonwoven fabric made of polypropylene being, interposed therebetween were integrated by fixing using a tape. Then, the resulting integrated electrode unit was encased in a cylindrical aluminum laminate bag having both ends open and one open end of the bag was fused at the lead portion of both electrodes. Subsequently, the non-aqueous electrolytic solution prepared preliminarily was dropped from the other open end.

The electrical double layer capacitor thus assembled was deaerated under 10 mmHg for 5 seconds and the open end from which the solution was injected was sealed by fusion.

The electrical double layer capacitor thus assembled was repeatedly charged and discharged under the conditions of a temperature of 20° C., a current of 0.36 mA and a voltage within a range from 0 to 3.9 V. After 1,000 cycles, the capacity was 0.50 mAh.

### Example 2

### (Design of Balance Between Positive Electrode Capacity and Negative Electrode Capacity in Electrical Double Layer Capacitor)

An electrode having an electrical double layer capacity of 0.50 mAh (an irreversible capacity of 0.097 mAh) made of acetylene black, CoO powder and polyvinylidene fluoride was produced as the negative electrode by mixing these components in the same weight ratio as in Example 1.

The positive electrode made of acetylene black, fine activated carbon powder manufactured by Calgon Mitsubishi Chemical Corporation and polyvinylidene fluoride was produced by mixing these components in the same weight ratio as in Example 1, and the electrical double layer capacity was adjusted to 0.30 mAh (Example 2-1), 0.40 mAh (Example 2-2), 0.50 mAh (Example 2-3), 0.60 mAh (Example 2-4 (the same as Example 1)), 0.70 mAh (Comparative Example 1-1), 0.80 mAh (Comparative Example 1-2) and 0.90 mAh (Comparative Example 1-3), respectively.

The potential of the negative electrode is designed so as to be respectively adjusted to 0.7, 0.5, 0.3, 0.1, 0.08, 0.08 and 0.08 V vs. Li/Li+ when the electrical double layer capacitor using the positive electrode having the electrical double layer capacity of 0.30, 0.40, 0.50, 0.60, 0.70, 0.80 and 0.90 mAh is charged to 3.9 V at 0.0036 mA.

The electrical double layer capacitor was assembled in the same manner as in Example 1 with the exceptions described above.

The electrical double layer capacitor thus assembled was repeatedly charged and discharged under the conditions of a temperature of 20° C., a current of 0.36 mA and a voltage within a range from 0 to 3.9 V. The ratio of the discharge capacity of the 1,000th cycle to the discharge capacity of the 10th cycle was determined.

The results are shown in Table 1.

TABLE 1

| | | | | | Comparative | Comparative | Comparative |
|---|---|---|---|---|---|---|---|
| | Example 2-1 | Example 2-2 | Example 2-3 | Example 2-4 | Example 1-1 | Example 1-2 | Example 1-3 |
| Electrical double layer | 0.30 | 0.40 | 0.50 | 0.60 | 0.70 | 0.80 | 0.90 |
| capacity of positive | | | | | | | |
| electrode (mAh) | | | | | | | |
| Negative electrode | 0.7 | 0.5 | 0.3 | 0.1 | 0.08 | 0.08 | 0.08 |
| potential upon completion | | | | | | | |
| of charging (V) | | | | | | | |
| Discharge capacity in the | 0.43 | 0.47 | 0.50 | 0.52 | 0.52 | 0.51 | 0.49 |
| 10th cycle (mAh) | | | | | | | |
| Discharge capacity in the | 0.40 | 0.45 | 0.49 | 0.50 | 0.46 | 0.44 | 0.41 |
| 1,000th cycle (mAh) | | | | | | | |
| Ratio of discharge capacity | 0.93 | 0.96 | 0.98 | 0.96 | 0.89 | 0.87 | 0.84 |

As is apparent from the results shown in Table 1, when the electrical double layer capacity of the positive electrode is more than 0.60 mAh, namely, when the negative electrode potential upon completion of charging is less than 0.1 V vs. Li/Li+, the ratio of the discharge capacity of the 1,000th cycle to the discharge capacity of the 10th cycle discontinuously decreases. That is considered because, when the charge potential of the negative electrode becomes less than 0.1 V vs. Li/Li+ by charging the electrical double layer capacity to 3.9 V, a reductive decomposition reaction of the ammonium salt is promoted. The reason why the ratio of the discharge capacity of the 1,000th cycle to the discharge capacity of the 10th cycle slightly decreases when the electrical double layer capacity of the positive electrode is 0.30 mAh is considered as follows: Namely, when charged to 3.9 V, the positive electrode becomes an overcharged state, and thus oxidative decomposition of the electrolytic solution has started.

### Example 3

### (Finding of Charge Potential at Which Negative Electrode Capacity Increases)

In the same manner as in Example 1, a working electrode made of acetylene black, CoO powder and polyvinylidene fluoride in a weight ratio of 10:80:10 was produced and the resulting working electrode is referred to as a working electrode 6a.

Also, in the same manner as in the case of the working electrode 6a, a working electrode made of acetylene black and polyvinylidene fluoride in a weight ratio of 90:10 was produced and the resulting working electrode is referred to as a working electrode 6b.

Furthermore, in the same manner as in the case of the working electrode 6a, a working electrode made of a fine activated carbon power, CoO powder and polyvinylidene fluoride in a weight ratio of 10:80:10 was produced and the resulting working electrode is referred to as a working electrode 6c.

Furthermore, in the same manner as in the case of the working electrode 6a, a working electrode made of a fine activated carbon power and polyvinylidene fluoride in a weight ratio of 90:10 was produced and the resulting working electrode is referred to as a working electrode 6d.

As a counter electrode, a foil-like electrode for an electrical double layer capacitor available from Hohsen Corporation was used after cutting into pieces. Also, a silver wire was used as a reference electrode, and a correction to a potential relative to a lithium reference was conducted.

As a non-aqueous electrolytic solution, a mixture obtained by mixing EC, PC and TEA·BF₄ in a molar ratio EC:PC:TEA·BF₄=4:4:1 was used.

The natural potential of all working electrodes was 2.9 V vs. Li/Li+ at 20° C. Subsequently, to these working electrodes, a cathodic current and an anodic current were repeatedly applied at a current density of 0.03 mA/cm² after setting the upper limit potential to 2.9 V vs. Li/Li+ and the lower limit potential respectively to 2.3 V vs. Li/Li+ (Comparative Example 2-1), 1.9 V vs. Li/Li+ (Comparative Example 2-2), 1.8 V vs. Li/Li+ (Comparative Example 2-3), 1.7 V vs. Li/Li+ (Example 3-1), 1.5 V vs. Li/Li+ (Example 3-2), 1.0 V vs. Li/Li+ (Example 3-3), 0.5 V vs. Li/Li+ (Example 3-4) and 0.1 V vs. Li/Li+ (Example 3-5), and then the electric capacity of the working electrodes was measured. Herein, the electric capacity was determined as the anodic current capacity in the 5th cycle.

In Table 2, a relative ratio of the electric capacity at each lower limit potential (electric capacity at each lower limit potential when the electric capacity is regarded to be 1.0 at a lower limit potential of 2.3 V) and a gradient of an increase in the electric capacity (relative ratio) to a decrease in the lower limit potential obtained by plotting these data are summarized.

TABLE 2

| | | Comparative | Comparative | Comparative | Example | Example | Example | Example | Example |
|---|---|---|---|---|---|---|---|---|---|
| | | Example 2-1 | Example 2-2 | Example 2-3 | 3-1 | 3-2 | 3-3 | 3-4 | 3-5 |
| Lower limit potential of negative | | 2.3 | 1.9 | 1.8 | 1.7 | 1.5 | 1.0 | 0.5 | 0.1 |
| electrode (V) | | | | | | | | | |
| Electric capacity | Working electrode 6a | 1.0 | 1.7 | 1.9 | 2.2 | 3.0 | 5.2 | 7.1 | 9.0 |
| (relative ratio) | Working electrode 6b | 1.0 | 1.6 | 1.8 | 2.6 | 4.4 | 9.3 | 19 | 26 |
| | Working electrode 6c | 1.0 | 1.7 | 1.8 | 2.3 | 2.9 | 5.1 | 6.9 | 8.7 |
| | Working electrode 6d | 1.0 | 1.6 | 1.8 | 2.5 | 3.9 | 7.1 | 13 | 17 |

| Gradient of increase | Working electrode 6a | 1.8 | 4.3 | |
|---|---|---|---|---|
| in electric capacity | Working electrode 6b | 1.6 | 9.5 | 18 |
| to decrease in lower | Working electrode 6c | 1.7 | 4.1 | |
| limit potential (V⁻¹) | Working electrode 6d | 1.6 | 6.6 | 11 |

Table 2 shows that, when the lower limit potential is decreased from 2.3 V to 0.1 V vs. Li/Li+ by applying the cathodic current, the electric capacity (relative ratio) increases and the gradient of the increase in the electric capacity to the decrease in the lower limit potential increases remarkably at 1.8 V vs. Li/Li+ as a border in all working electrodes. Namely, it is found that the effect of increasing the electric capacity is small up to the lower limit potential of 1.8 V vs. Li/Li+ (Comparative Examples 2-1 to 2-3) even if the lower limit potential is lowered, whereas the decrease in the lower limit potential significantly increases the electric capacity when the lower limit potential becomes less than 1.8 V vs. Li/Li+ (Examples 3-1 to 3-3). As is apparent from the results, by setting the negative electrode potential upon completion of charging to less than 1.8 V, it is possible to obtain a relatively larger negative electrode capacity to the decrease in the negative electrode potential as compared with setting it to 1.8 V or more.

It is also found that, when acetylene black (working electrode 6b) is used as the negative electrode material, a larger electric capacity can be obtained especially at the lower limit potential of less than 1.8 V vs. Li/Li+ as compared with activated carbon (working electrode 6d).

### Example 4

### (Examination of Anion of Ammonium Salt)

In the same manner as in Example 1, an electrode having an electrical double layer capacity of 0.50 mAh (an irreversible capacity of 0.097 mAh) was produced as the negative electrode, and an electrode having an electrical double layer capacity of 0.60 mAh was produced as the positive electrode.

As a non-aqueous electrolytic solution, a solution dissolving the ammonium salt as shown in Table 3 and having a composition of EC:EMC:ammonium salt=3:8:0.3 (molar ratio) was used. An electrical double layer capacitor was assembled in the same manner as in Example 1 with the exceptions described above.

The electrical double layer capacitor thus assembled was repeatedly charged and discharged under the conditions of a temperature of 20° C., a current of 0.36 mA and a voltage within a range from 0 to 39 V. The ratio of the discharge capacity in the 1,000th cycle to the discharge capacity in the 10th cycle was determined, as shown in Table 3.

TABLE 3

| | | Ratio of |
|---|---|---|
| | | discharge |
| | Ammonium salts | capacity |
| Example 4-1 | TEA•BF₄ | 0.93 |
| Example 4-2 | TEA•PF₆ | 0.91 |
| Example 4-3 | TEA•BF₄:TEA•BOB = 0.29:0.01 | 0.95 |
| | (molar ratio) | |
| Example 4-4 | TEA•PF₆:TEA•BOB = 0.29:0.01 | 0.93 |
| | (molar ratio) | |
| Example 4-5 | TEA•ClO₄ | 0.95 |
| Example 4-6 | TEA•TFSI | 0.94 |
| Example 4-7 | TEA•BETI | 0.93 |
| Example 4-8 | TEA•MBSI | 0.92 |
| Example 4-9 | TEA•CHSI | 0.90 |
| Example 4-10 | TEA•TFSI:TEA•BF₄ = 0.25:0.05 | 0.95 |
| | (molar ratio) | |
| Example 4-11 | TEA•BETI:TEA•BF₄ = 0.25:0.05 | 0.94 |
| | (molar ratio) | |
| Example 4-12 | TEA•MBSI:TEA•BF₄ = 0.25:0.05 | 0.93 |
| | (molar ratio) | |
| Example 4-13 | TEA•CHSI:TEA•BF₄ = 0.25:0.05 | 0.91 |
| | (molar ratio) | |
| Example 4-14 | TEA•BOB | 0.93 |
| Example 4-15 | TEA•CF₃BF₃ | 0.94 |
| Example 4-16 | TEA•C₂F₅BF₃ | 0.93 |
| Example 4-17 | TEA•C₃F₇BF₃ | 0.91 |
| Example 4-18 | TEA•(C₂F₅)₃PF₃ | 0.90 |

TEA•BF₄: Tetraethylammonium tetrafluoroborate
TEA•PF₆: Tetraethylammonium hexafluoroborate
TEA•ClO₄: Tetraethylammonium perchlorate
TEA•TFSI: Tetraethylammonium bis[trifluoromethanesulfonyl]imide
TEA•BETI: Tetraethylammonium bis[pentafluoroethanesulfonyl]imide
TEA•MBSI: Tetraethylammonium [trifluoromethanesulfonyl][nonafluorobutanesulfonyl]imide
TEA•CHSI: Tetraethylammonium cyclohexafluoropropane-1,3-bis[sulfonyl]imide
TEA•BOB: Tetraethylammonium bis[oxalate(2-)]borate
TEA•CF₃BF₃: Tetraethylammonium trifluoromethyltrifluoroborate
TEA•C₂F₅BF₃: Tetraethylammonium pentafluoroethyltrifluoroborate
TEA•C₃F₇BF₃: Tetraethylammonium heptafluoropropyltrifluoroborate
TEA•(C₂F₅)₃PF₃: Tetraethylammonium tris[pentafluoroethyl]trifluorophosphate

As is apparent from the results shown in Table 3, the electrical double layer capacitor having satisfactory cycle characteristics can be obtained by using the ammonium salt containing the BF₄ ion, the TFSI ion, the BETI ion, the ClO₄ ion, the CF₃BF₃ ion, the C₂F₅BF₃ ion and the BOB ion as the anion.

### Example 5

### (Examination of Cation of Ammonium Salt)

In the same manner as in Example 1, an electrode having an electrical double layer capacity of 0.50 mAh (an irreversible capacity of 0.097 mAh) was produced as a negative electrode, and an electrode having an electrical double layer capacity of 0.60 mAh was produced as a positive electrode.

As a non-aqueous electrolytic solution, a solution dissolving the ammonium salt as shown in Table 4 and having a composition of EC, EMC and the ammonium salt in a molar ratio of 3:8:0.3 was used. An electrical double layer capacitor was assembled in the same manner as in Example 1 with the exceptions described above.

The electrical double layer capacitor thus assembled was repeatedly charged and discharged under the conditions of a temperature of 20° C., a current of 0.36 mA and a voltage within a range from 0 to 3.9 V. The ratio of the discharge capacity in the 1,000th cycle to the discharge capacity in the 10th cycle was determined, as shown in Table 4.

TABLE 4

| | | Ratio of |
|---|---|---|
| | | discharge |
| | Ammonium salts | capacity |
| Example 5-1 | TMA•TFSI:TMA•BF₄ = 0.25:0.05 | 0.96 |
| | (molar ratio) | |
| Example 5-2 | TEA•TFSI:TEA•BF₄ = 0.25:0.05 | 0.95 |
| | (molar ratio) | |
| Example 5-3 | TPA•TFSI:TPA•BF₄ = 0.25:0.05 | 0.93 |
| | (molar ratio) | |
| Example 5-4 | TBA•TFSI:TBA•BF₄ = 0.25:0.05 | 0.90 |
| | (molar ratio) | |
| Example 5-5 | TMEA•TFSI:TMEA•BF₄ = 0.25:0.05 | 0.97 |
| | (molar ratio) | |
| Example 5-6 | TMPA•TFSI:TMPA•BF₄ = 0.25:0.05 | 0.98 |
| | (molar ratio) | |
| Example 5-7 | TMBA•TFSI:TMBA•BF₄ = 0.25:0.05 | 0.96 |
| | (molar ratio) | |

TMA•BF₄: Tetramethylammonium tetrafluoroborate
TEA•BF₄: Tetraethylammonium tetrafluoroborate
TPA•BF₄: Tetrapropylammonium tetrafluoroborate
TBA•BF₄: Tetrabutylammonium tetrafluoroborate
TMEA•BF₄: Trimethylethylammonium tetrafluoroborate
TMPA•BF₄: Trimethylpropylammonium tetrafluoroborate
TMBA•BF₄: Trimethylbutylammonium tetrafluoroborate
TMA•TFSI: Tetramethylammonium bis[trifluoromethanesulfonyl]imide
TEA•TFSI: Tetraethylammonium bis[trifluoromethanesulfonyl]imide
TPA•TFSI: Tetrapropylammonium bis[trifluoromethanesulfonyl]imide
TBA•TFSI: Tetrabutylammonium bis[trifluoromethanesulfonyl]imide
TMEA•TFSI: Trimethylethylammonium bis[trifluoromethanesulfonyl]imide
TMPA•TFSI: Trimethylpropylammonium bis[trifluoromethanesulfonyl]imide
TMBA•TFSI: Trimethylbutylammonium bis[trifluoromethanesulfonyl]imide

As is apparent from the results shown in Table 4, the electrical double layer capacitor having satisfactory cycle characteristics can be obtained by using the ammonium salt containing the TMA ion, the TMEA ion, the TMPA ion and the TMBA ion as the cation.

### Example 6

### (Assembling of Hybrid Capacitor)

An electrode having an electrical double layer capacity of 0.16 mAh (an irreversible capacity of 0.031 mAh), which is the same electrode as that in which the reductive decomposition potential of the ammonium salt was measured in Example 1, was produced and used as a negative electrode.

An electrode having an electrical double layer capacity of 12 mAh was produced as a positive electrode by adjusting the coating weight of a paste containing acetylene black, fine activated carbon powder manufactured by Calgon Mitsubishi Chemical Corporation and polyvinylidene fluoride in the same weight ratio as in Example 1.

As a non-aqueous electrolytic solution, a solution having a composition of EC:EMC:TMPA·BF₄:LiBF₄=3:8:0.5:0.5 (molar ratio) was used.

An electrical double layer capacitor was assembled in the same manner as in Example 1 with the exceptions described above.

The electrical double layer capacitor thus assembled was repeatedly charged and discharged under the conditions of a temperature of 20° C., a current of 0.36 mA and a voltage within a range from 0 to 3.5 V. Then, the electric capacity in the 2nd cycle and the electric capacity in the 10th cycle were measured. As a result, they were 9.8 mAh and 9.6 mAh, respectively.

After 10 cycles, a part of the hybrid capacitor was opened and a reference electrode made of a nickel lead to which a small piece of lithium metal has been pressure-bonded was inserted, and then a change in the potential of the respective negative and positive electrode at a voltage within a range from 0 to 3.5 V was measured. As a result, the potential of the negative electrode was 0.5 V vs. Li/Li+ upon completion of charging and was 3.1 V vs. Li/Li+ upon completion of discharging, whereas the potential of the positive electrode was 4.0 V vs. Li/Li+ upon completion of charging and was 3.1 V vs. Li/Li+ upon completion of discharging. In other words, it is found that the potential of the negative electrode upon completion of charging is in a range of 0.1 V vs. Li/Li+ or more, thus enabling charging and discharging repeatedly.

The reason why the electric capacity of 9.6 mAh is obtained even if the negative electrode having the electrical double layer capacity of 0.16 mAh is used is that the CoO powder contained in the negative electrode reversibly causes an electrochemical reaction.

As described above, an aspect of the present invention is directed to an electrochemical energy storage device comprising a positive electrode, a negative electrode, and a non-aqueous electrolytic solution containing an ammonium salt, wherein the negative electrode potential upon completion of charging is set to less than 1.8 V and 0.1 V or more relative to a lithium reference. With the above constitution, much more electrochemical energy than that of a conventional electrical double layer capacitor can be stored and also efficiency upon every charging and discharging cycle is improved without causing a reductive decomposition reaction of the ammonium salt on the negative electrode, resulting in a long cycle life.

In the present invention, an anion of the ammonium salt is preferably at least one kind selected from the group consisting of a tetrafluoroborate ion, a bis[trifluoromethanesulfonyl]imide ion, a bis[pentafluoroethanesulfonyl]imide ion, a perchlorate ion, a trifluoromethanetrifluoroborate ion, a pentafluoroethanetrifluoroborate ion, and a bis [oxalate (2-)borate ion. With the above constitution, the anion is decomposed on the negative electrode to form a stable film and therefore a reaction of inserting the cation of the ammonium salt into the interlayers of a carbon material of the negative electrode can be suppressed, thus enabling improvement of the charging and discharging cycle life of the electrochemical energy storage device.

In the present invention, a cation of the ammonium salt is preferably at least one kind selected from the group consisting of a tetramethylammonium ion, a trimethylethylammonium ion, a trimethylpropylammonium ion, and a trimethylbutylammonium ion. With the above constitution, since the cation is a quaternary ammonium cation having three or more methyl groups, a reaction of inserting the ammonium cations into the interlayers of the carbon material of the negative electrode can be suppressed.

In the present invention, the non-aqueous electrolytic solution preferably contains, in addition to the ammonium salt, a lithium salt. With the above constitution, since lithium ions exist in the non-aqueous electrolytic solution, the energy density of the electrochemical energy storage device is improved and a reaction of inserting the ammonium cations into the interlayers of the carbon material of the negative electrode can be suppressed.

In the present invention, the negative electrode preferably contains carbon black as a carbon material. With the above constitution, since carbon black causes less irreversible reaction with lithium, it is possible to obtain an electrochemical energy storage device having a large discharge capacity after charging at a negative electrode potential of less than 1.8 V relative to the lithium reference.

Furthermore, in the present invention, the non-aqueous electrolytic solution preferably contains at least one kind of non-aqueous solvent selected from the group consisting of ethylene carbonate, propylene carbonate and γ-butyrolactone. With the above constitution, since the non-aqueous solvent can dissolve the ammonium salt in a high concentration, an electrochemical energy storage device having a high energy density can be obtained.

In the electrochemical energy storage device of the present invention, high electric capacity is obtained and, since a reductive decomposition reaction of the ammonium salt on the negative electrode is avoided, efficiency upon every charging and discharging cycle is improved, thus resulting in a long cycle life.

In the electrochemical energy storage device of the present invention, since balance between positive electrode capacity and negative electrode capacity is optimized, high electric capacity is obtained, and thus efficiency upon every charging and discharging cycle is improved, resulting in a long cycle life.

This application is based on Japanese Patent application serial No. 2006-298818 filed in Japan Patent Office on Nov. 2, 2006, the contents of which are hereby incorporated by reference.

Although the present invention has been fully described by way of example, it is to be understood that various changes and modifications will be apparent to those skilled in the art. Therefore, unless otherwise such changes and modifications depart from the scope of the present invention hereinafter defined, they should be construed as being included therein.

What is claimed is:

1. An electrochemical energy storage device comprising a positive electrode, a negative electrode, and a non-aqueous electrolytic solution containing an ammonium salt, wherein a negative electrode potential upon completion of charging is set to less than 1.8 V and 0.1 V or more relative to a lithium reference.

2. The electrochemical energy storage device according to claim 1, wherein the negative electrode potential upon completion of charging is set to 1.0 V or less and 0.1 V or more relative to the lithium reference.

3. The electrochemical energy storage device according to claim 1, wherein a cation of the ammonium salt is a quaternary ammonium cation comprising straight-chain alkyl groups each having 4 or less carbon atoms.

4. The electrochemical energy storage device according to claim 1, wherein a cation of the ammonium salt is at least one kind selected from the group consisting of a tetramethylammonium ion, a trimethylethylammonium ion, a trimethylpropylammonium ion and a trimethylbutylammonium ion.

5. The electrochemical energy storage device according to claim 1, wherein an anion of the ammonium salt is at least one kind selected from the group consisting of a tetrafluoroborate ion, a bis[trifluoromethanesulfonyl]imide ion, a bis[pentafluoroethanesulfonyl]imide ion, a perchlorate ion, a trifluoromethanetrifluoroborate ion, a pentafluoroethanetrifluoroborate ion and a bis [oxalate (2-)borate ion.

6. The electrochemical energy storage device according to claim 1, wherein an anion of the ammonium salt is a tetrafluroborate ion and a cation of the ammonium salt is a trimethylpropylammonium ion.

7. The electrochemical energy storage device according to claim 1, wherein the negative electrode contains carbon black as a carbon material.

8. The electrochemical energy storage device according to claim 1, wherein the negative electrode contains activated carbon as a carbon material.

9. The electrochemical energy storage device according to claim 1, wherein the non-aqueous electrolytic solution further contains a lithium salt.

10. The electrochemical energy storage device according to claim 9, wherein the lithium salt is at least one kind selected from the group consisting of lithium tetrafluoroborate, lithium bis[trifluoromethanesulfonyl]imide and lithium perchlorate.

11. The electrochemical energy storage device according to claim 1, wherein the non-aqueous electrolytic solution contains at least one kind of a non-aqueous solvent selected from the group consisting of ethylene carbonate, propylene carbonate and γ-butyrolactone.
